(19) United States
(12) Patent Application Publication
(10) Pub. No.: US 2009/0037611 A1
(43) Pub. Date: Feb. 5, 2009

(54) SYSTEM AND METHOD FOR TRANSFERRING, IN PARTICULAR AUTHORIZATION-RELEVANT DATA

(76) Inventor: Wolfgang Richter, Stanberg (DE)

Correspondence Address: K.F. ROSS P.C., 5683 RIVERDALE AVENUE, SUITE 203 BOX 900, BRONX, NY, 10471-0900, US

(21) Appl. No.: 12/093,339

(22) PCT Filed: Nov. 10, 2006
(86) PCT No.: PCT/EP2006/010827

§ 371 Date: Aug. 18, 2008

(30) Foreign Application Priority Data
Nov. 10, 2005 (DE) 10 2005 053 745.6

(51) Int. Cl. G06F 12/02

(52) U.S. Cl. 710/13

(57) ABSTRACT

The invention relates to a system, the individual components thereof, and to a method for executing an electronic data transfer, particularly of authorization-relevant or otherwise privileged or sensitive data. The aim of the invention is to provide solutions with which it is possible, while resorting to, in particular, established or conventional mobile telephone mobile storage devices, to effect or coordinate, in a particularly advantageous manner, a provision of data or recording of data. According to a first aspect of the invention, this aim is achieved by a mobile data provision system with a storage unit and with an interface unit. The interface unit has a standard interface for executing a data transfer over a standard interface system and, in addition to this standard interface, an additional interface is provided for executing a data transfer based on a modulated electrical field.

### CROSS REFERENCE TO RELATED APPLICATIONS

This application is the US national phase of PCT application PCT/EP2006/010827, filed 10 Nov. 2006, published 18 May 2007 as WO 2007/054349, and claiming the priority of German patent application 102005053745.6 itself filed 10 Nov. 2005, whose entire disclosures are herewith incorporated by reference.

The invention relates to a system, its individual known components, and a method of transferring electronic data, in particular, of authorization-relevant or otherwise privileged or sensitive data.

For purposes of electronically transferring data, transmission systems are known through which storage systems involving a computer system are coupled to each other. When connected it is possible to read or modify the data entry of the two storage units. In addition, it is possible to transfer data between storage units wirelessly, in particular, in a radio-based approach (e.g. Bluetooth standard) or also optically. Storage units are now known that are in the form of extremely compact structures, in particular, portable memory cards (e.g. Smart Media Cards), small external hard drives, and, in particular, USB memory sticks. These commercially available storage media can be directly connected through standardized and commercially available interface equipment to a working computer, a recording device, or a play-back device.

The fundamental problem to be solved by the invention is to provide solutions by which it is possible in an especially advantageous manner to effect or to coordinate supplying or recording data by utilizing, in particular, established or commercially available portable storage devices.

This problem is solved according to a first aspect of this invention by a portable data-supply system comprising a storage unit comprising a storage unit and an interface unit, the interface unit including a standard interface for transferring data through a standard interface system, and where in addition to this standard interface a supplemental interface is provided for transferring data via a modulated electrical field.

This approach advantageously enables data to be recorded on commercially available data media and data to be transferred from or to the storage unit, or to an intermediate system coupled to the storage unit through a modulated, quasi-static electrical field, or to coordinate the transfer by signal-technology-based means. This enables the data entry into the storage unit to be modified through the signal or information content of the modulated field introduced to the supplemental interface. It is also possible to read the data entries of the storage unit and to make available the corresponding information for other purposes. It is also possible for the supplemental interface to supply data that is required to obtain access to the data stored in the storage unit, or to decrypt this data.

In an especially preferred embodiment of the invention, the standard interface is implemented as a USB interface. This type of interface is generally present on current computer systems without any need for upgrades. The standard interface can also be a card-contact interface, e.g. Smart Media. It is possible for the storage unit to be a memory card that is integrated into a USB carrier structure. The circuit of the supplemental interface can also be integrated into this carrier structure. The standard interface can furthermore be implemented in the form of an Ethernet, IR interface, RFID, or even WLAN interface.

All in all, the portable data-supply system can preferably be in the form of a USB-memory-stick-like element. The storage unit itself can be in the form of a standard USB memory stick or a memory card.

The supplemental interface can be integrated into the storage unit. Preferably, however, the supplemental interface and storage unit are separate. In particular, it is possible to couple the supplemental interface to the storage unit through the standard interface.

It is possible to design the system such that the standard interface is not accessible when connected, or also so that the memory card is not removable from its housing. It is thus possible, in particular, to integrate the supplemental interface in a USB memory stick cap such that in the attached state communication is possible only through the supplemental interface and access to the USB interface is possible only once the cap is removed.

The supplemental interface can be integrated in a housing, in particular, in a card receiving structure or a USB memory stick housing. The data-supply system preferably comprises a power supply, e.g. a battery. The power supply can be in the form of a rechargeable battery, charging being preferably effected through the standard interface.

The system is preferably configured such that a signal sequence is able to be coupled through the supplemental interface, this sequence functioning to coordinate, in particular, make possible data transfer through the standard interface. The system can be configured such that reading, and/or modifying the data entry of the storage unit is effected through the supplemental interface.

The data-supply system according to the invention can be integrated in a key system, in particular, a room key or a motor-vehicle key. The data-supply system is also capable of being used as a multifunction employee ID, time clock, and/or ID sensor.

It can also be used to record data that typically accrues within the proximity of a user, in particular, physiological measured data, local data, log book entries, and activity data (e.g. tool use).

It is possible to make access to the data content of the storage unit dependent on what data or information is fed into the supplemental interface. For example, it is possible to create a portable data carrier, in particular, a USB memory stick that is readable or writable only when a signal is fed into the supplemental interface, which signal is classified by an adjacent user as being permitted or otherwise enabling access or decryption.

The data set in the storage unit can, for example, be a digital cash data set. This data set is usable only when certain conversion criteria are met or other controlling actions can be made based on feeding in additional information or signal sequences.

The data transfer system according to the invention, “Near field-Datastick,” can be designed such that the latter influences a user with a modulated field or alternating charge either continuously or pulse-wise, and imparts to this user a modulated data-carrying field-electric aura. The data stored in the stick can be sent to external receiving devices through the extremities, or through the proximate environment of the user so as to trigger switching and/or signaling processes. Conversely, a person can pick up data from external transmitting devices in response to approaching and/or touching something with his/her body, and send the data to the exemplary alternating charge receiver in the stick, store it there, and/or trigger actions in the stick (e.g. output MP3 sound data).

In terms of the circuit-engineering implementation of the supplemental interface, i.e., of the interface for communicating through a quasi-static, modulated electrical field, special reference is made to patent applications that originate with the applicant, in particular, granted patent 103 15 845 [US 20006/0261672]. The interface can be designed such that it enables only unidirectional data flow, preferably bidirectional data transfer. The data transfer can be effected in particular based on ASK, FSK, or also (Q-)PSK data modulation. Based on this data modulation, the voltage applied to an electrode device, and thus the field surrounding this electrode device is modulated. Read access, or also write access, can be done on the content of the storage device through the electrode device. Details for this type of circuit are also described in the international patent application PCT/EP2005/010846 [WO/2006/040095] originating with the applicant. The content of this application is integrated fully by this reference into the present application.

Additional details and features of the invention are revealed by the following description in combination with the drawing. In the drawing:

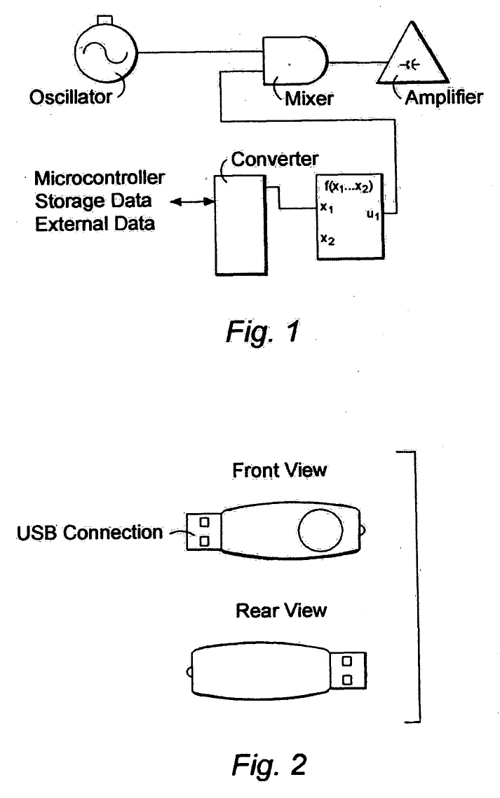

FIG. 1 is a schematic diagram illustrating the basic design of a system according to the invention;

FIG. 2 is another schematic diagram illustrating an embodiment;

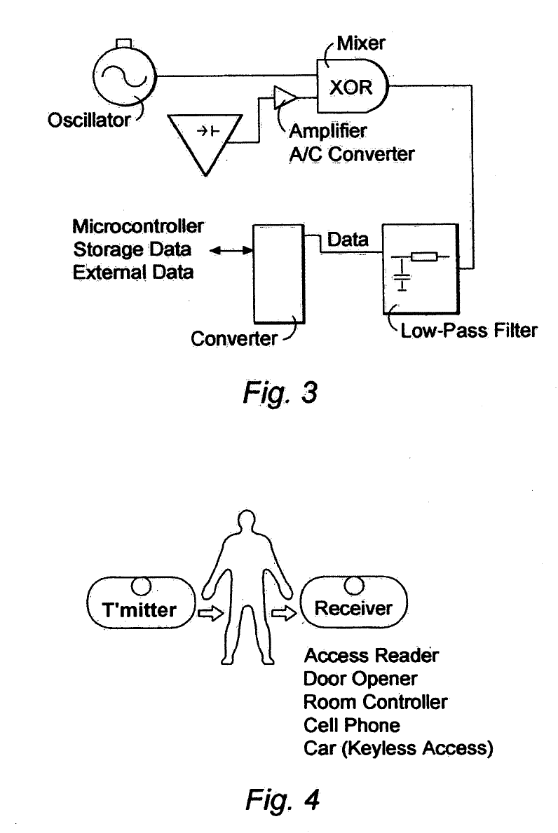

FIG. 3 shows the layout of a receiver circuit;

FIG. 4 is another schematic diagram illustrating details of the concept according to the invention.

Portable data storage units have been available on the market for a considerable time now that people carry with them under various circumstances. These are essentially classified into entertainment devices, such as MP3 players (for example), or computer-generated data in storage devices that is to be transferred from one device to another device. Based on their purpose, these portable data storage units are implemented as small plug-in units (e.g. USB memory stick). Depending on use, they are equipped with a battery, or are supplied with power when plugged in (e.g. USB). The latter system is also an interface for data entered through the plug-in component, as known from DVBT receivers or sound cards. Carrying these devices is part of the zeitgeist and is accepted by consumers.

According to the invention, a frequency-generating component (oscillator) is provided on a memory stick. This generates a predetermined carrier frequency. Data coming from a storage unit can be applied by means of a suitable mixer to this carrier frequency. In addition, data can be applied that is supplied by external inputs. This can initially be analog data that has been digitized (ADC) or simply digital data that was supplied through a communication protocol. The output of the carrier signal modulated with the data is passed to an output surface. This generates an a/c field whose frequency corresponds to the carrier frequency. By means of a series resonant circuit, the voltage level can be raised as necessary. The output of frequencies modulated with data can be effected cyclically or upon request. The request can occur either by pressing a button or be initiated externally, e.g. by a corresponding pulse. The invention furthermore has the capability of receiving a/c fields, decoding this data contained therein, and supplying it to a storage unit, or activating the above-described transmitter unit.

Configuration with data occurs, for example, when the portable storage unit (memory stick) is connected to a computer (e.g. laptop). Appropriate software allows predetermined code sequences to be entered. If the portable data storage unit has an analog reproduction device (e.g. MP3 player), the inputted data can also be played back as selected speech or sound sequences.

### FIRST EMBODIMENT

A hotel guest receives a portable data carrier when checking in. During the reception process, he/she indicates his/her requirements with regard to room temperature, water temperature, wake-up times, special service, etc. These data are entered into a portable memory stick that the hotel guest carries from now on for the purpose of utilizing the expanded service. Immediately in front of his/her hotel room, an appropriate receiver in the door lock checks whether a/c fields loaded with data as well as the codes contained therein are present, and whether there is a match. The door then opens. A corresponding receiver situated in each room adjusts the climate control system to the values requested by the guest in response to his/her approach. In response to entering the bathroom and turning on the bath water, a mixing device sets the water temperature when touched. If appliances or objects are used occasionally, this use can be recorded by the stick and stored, and possibly be computed at another site. At golf courses, the guest takes an electric vehicle and drives it with authorization, the drive time being stored in the stick. What is of particular significance here is that the storing operation can occur only in the immediate vicinity of an acting person. Since the alternating field decreases in strength with the cube of the distance, propagation of more than 50 cm is possible or desirable only in the rarest of cases. Instead, it is appropriate for the alternating field to be transmitted to corresponding receivers during some action. This is shown in FIG. 4.

### Exemplary Communication Devices

1. Data are transferred from a PC to an inserted stick.

2. The stick is removed from the PC and carried by the person, then sends encoded sequences via the a/c communication interface. This can occur cyclically or as requested.

3. Received data that arrive by this path at the storage device are stored temporarily there until the stick is again inserted in the PC. This data can then be retrieved. This too can occur automatically.

4. A stick inserted in the PC switches automatically to receive, and can now decode a/c data supplied externally and cause an evaluation to occur in the PC.

### Example of Use

A patch affixed to the chest records the heart rate of a person and applies this analog data to a carrier signal that is then returned to the skin of the person. This now creates a capacitive field to a memory stick enclosed in a PC, the memory stick having been loaded with the inventive system. This records the heart rate and displays it as an EKG (electrocardiogram) on the screen of the laptop. This data can be supplied through a communication device to a competent physician (Internet, DSL).

Enhancing convenience through the use of the invention

In addition, the circuit according to the invention can be provided with inputs. These can be buttons and/or analog and/or digital inputs. Light-emitting diodes (LEDs), analog and/or digital interfaces, optical or acoustic output devices can function as the outputs. For pure ? information, a vibrator can be activated. If required, the invention can also be used to activate a radio system in order to extend the data transmission range. Activation then always occurs in the form of an action or an approach.

### Another Example

The previously described EKG patch sends its data to the receiver of the memory stick carried in a pocket. An appropriate controller checks the heart rate for cardiac arrhythmia. Should such be detected, a connection is established to a mobile telephone located in the vicinity and a physician is informed electronically. The physician can then return the patient's call and provide appropriate instructions.

1. A portable data-supply system comprising a storage unit and an interface unit, the interface unit including a supplemental interface for transferring data through a standard interface system, and where in addition to that standard interface a supplemental interface is provided for transferring data via a modulated electrical field.

2. The data-supply system according to claim 1 wherein the standard interface is a USB interface.

3. The data-supply system according to claim 1 wherein the standard interface is a card-contact interface.

4. The data-supply system according to claim 1 wherein the standard interface is an IR interface.

5. The data-supply system according to claim 1 wherein the standard interface is a WLAN interface or RFID interface.

6. The data-supply system according claim 1 wherein the storage unit is a USB memory stick.

7. The data-supply system according to claim 1 wherein the storage unit is a memory card.

8. The data-supply system according to claim 1 wherein the supplemental interface is integrated in the storage unit.

9. The data-supply system according to claim 1 wherein the supplemental interface and the storage unit are separable from each other.

10. The data-supply system according to claim 1 wherein the supplemental interface is couplable to the storage unit through the standard interface.

11. The data-supply system according to claim 1 wherein the supplemental interface is integrated in a USB memory stick cap.

12. The data-supply system according to claim 1 wherein the supplemental interface is integrated in a card receiving structure.

13. The data-supply system according to claim 1 wherein the data-supply system includes a power supply.

14. The data-supply system according to claim 1 wherein the power supply is a battery.

15. The data-supply system according to claim 1 wherein the power supply is a rechargeable battery, the charging is effected through the standard interface, the system being configured such that a signal sequence is able to be coupled in through the supplemental interface, this sequence per se functioning to coordinate and enable data transfer through the standard interface.

16. The data-supply system according to claim 1 wherein the system is configured such that reading and/or modification of the data entry of the storage unit is effected through the supplemental interface.

17. The data-supply system according to claim 1 wherein the system is integrated in a key system, in particular, a room key or a motor-vehicle key.
